(19) United States
(12) Patent Application Publication
(10) Pub. No.: US 2010/0328047 A1
(43) Pub. Date: Dec. 30, 2010

(54) COMMUNICATION SESSION ESTABLISHMENT

(76) Inventors: Joni Jorma Jantunen, Helsinki (FI); Jaakko Valtteri Varteva, Veikkola (FI)

Correspondence Address: Locke Lord Bissell & Liddell LLP;Attn: IP Docketing, Three World Financial Center, New York, NY, 10281-2101, US

(21) Appl. No.: 12/867,698

(22) PCT Filed: Mar. 17, 2008
(86) PCT No.: PCT/FI08/50120

§ 371 Date: Aug. 13, 2010

(51) Int. Cl. H04Q 5/22

(52) U.S. Cl. 340/10.4

(57) ABSTRACT

A radio frequency identification system that has a radio frequency identification reader and a set of tags, in which the tags are interrogated in order to establish a connection with a responding tag. The responding tag determines a desired data rate and indicates this desired data rate to the reader during the interrogation so as to set the data rate for subsequent communication with the reader.

### TECHNICAL FIELD

The present invention generally relates to communication establishment. More particularly, though not exclusively, the invention relates to defining communication parameters at least partly by a radio frequency identification communication unit that is establishing a communication session with a radio frequency identification access unit.

### BACKGROUND

Present Radio Frequency IDentification (RFID) standards such as near field communication (NFC) support data rates up to a few hundreds kilobits per second and the memory capacity of RFID tags is typically limited, ranging from a couple of bytes to few kilobytes. However, due to advances in semiconductor technologies and especially in the non-volatile memory area, it is anticipated that so-called mass memory tags with memory capacity in the order of megabits or gigabits will be commercially feasible in a few years. In order to secure a good user experience with resulting large data transfers, RFID communication data rates should be significantly improved so as to maintain data transfer caused delays short enough. New Impulse UWB (I-UWB) based communication systems are being developed for significantly increased data rates. Therefore, I-UWB is expected to become an important enabler technology in RFID.

The development of the I-UWB system is still in an early stage, but it is expected that I-UWB will involve the following steps on a communication session establishment before commencing actual data transfer, such as:
1. a reader activates its radio frequency (RF) output to energize proximate tags
2. reader vs. tag synchronisation both in terms of radio frequency and timing
3. the reader selects communication parameters, such as data rate and modulation scheme
4. the reader applies a collision avoidance procedure in order to select one tag from multiple tags that reside within the reader's operating range

In case of passive RFID tags that is communication units which are powered by incoming radio signal, the available energy has very wide dynamic range because it heavily depends on the distance between a powering RFID communication unit (i.e. a reader) and a tag. Further fluctuation in the power is incurred if the reader is located within a handheld device that is moved in relation to the tag.

When the reader and the tag are relatively far away from each other, or if particularly power consuming operations are required at the tag, the energy that is available through remote RF powering may not suffice for I-UWB communication at a full data rate. Yet, it is useful in some applications for the reader to at least detect the presence of a tag and to potentially also gain some information about the type and content of the tag. For this kind of data exchange the full data rate may not be necessary. On the other hand, when the reader and the tag are very close to each other, the tag may be powered that well that the full data rate may be usable even together with power hungry functions such as the accessing a mass memory of the tag. In this case, large amounts of data such as audio or video content can be conveniently transferred.

### SUMMARY

According to a first aspect there is provided an apparatus, comprising:

a transceiver configured to transmit first radio signals adapted to interrogate communication units, and to responsively receive second radio signals from a responding communication unit;

wherein the transceiver is further configured to determine based on the first and second radio signals a first data rate desired by the responding communication unit and to communicate with the responding communication unit using the first data rate.

The transceiver may be configured to determine the first data rate by testing different data rates and detecting associated responses.

The testing may involve transmitting data pulses during particular data frames and checking if responses are detected.

The transceiver may be configured to determine a predetermined response pattern as an indication of the first data rate.

The transmitter may be further configured to transmit predetermined pulses and the predetermined response pattern may comprise selective responses to the predetermined pulses.

The transceiver may be configured to perform the determination of the data rate in connection with a second phase of interrogation in which a timing synchronisation is being established between the apparatus and the responding communication unit.

The first radio signals may be adapted to interrogate radio frequency identification system communication units.

According to a second aspect of the invention, there is provided a method in an apparatus, comprising:

transmitting first radio signals adapted to interrogate communication units, and

responsively receiving second radio signals from a responding communication unit;

determining based on the first and second radio signals a first data rate desired by the responding communication unit; and

communicating with the responding communication unit using the first data rate.

According to a third aspect of the invention, there is provided a computer program for controlling an apparatus when executing the program, the program comprising:

computer executable program code configured to enable the apparatus to transmit first radio signals adapted to interrogate communication units, and to responsively receive second radio signals from a responding communication unit; and

computer executable program code configured to enable the apparatus to determine based on the first and second radio signals a first data rate desired by the responding communication unit and to communicate with the responding communication unit using the first data rate.

According to a fourth aspect of the invention there is provided a communication unit, comprising:

a transceiver configured to receive interrogation signals from an interrogation source and to provide a response to the interrogation signals;

wherein the transceiver is configured to identify to the interrogation source a data rate that is desired by the communication unit on the providing of the response to the interrogation signals and to communicate with interrogation source using the desired data rate.

The transceiver may be configured to communicate with the interrogation source using a predetermined response pattern so as to identify the desired data rate.

The transceiver may be configured to successfully respond to the interrogation signals only when the interrogation signals have a data rate desired by the communication unit.

According to a fifth aspect there is provided a method in a communication unit comprising:

receiving interrogation signals from an interrogation source;

responding to the interrogation signals; and

identifying to the interrogation source a data rate that is desired by the communication unit on responding to the interrogation signals and communicating with the interrogation source using the desired data rate.

According to a sixth aspect there is provided a computer program for controlling a communication unit when executing the program, the program comprising:

computer executable program code configured to enable the communication unit to receive interrogation signals from an interrogation source;

computer executable program code configured to enable the communication unit to provide a response to the interrogation signals; and

computer executable program code configured to enable the communication unit to identify to the interrogation source a data rate that is desired by the communication unit on providing the response to the interrogation signals and to communicate with the interrogation source using the desired data rate.

The computer program according to the third aspect and/or of the sixth aspect may be carried by a carrier. The carrier may be selected from a group consisting of: a data signal; a radio signal; and a memory medium.

The memory medium may be a digital data storage such as a data disc or diskette, optical storage, magnetic storage, holographic storage, phase-change storage (PCM) or opto-magnetic storage. The memory medium may be formed into a device without other substantial functions than storing memory or it may be formed as part of a device with other functions, including but not limited to a memory of a computer, a chip set, and a sub assembly of an electronic device.

According to a seventh aspect there is provided a system comprising an apparatus, the apparatus comprising:

a first transceiver configured to transmit first radio signals adapted to interrogate communication units, and to responsively receive second radio signals from a responding communication unit;

wherein the first transceiver is further configured to determine based on the first and second radio signals a first data rate desired by the responding communication unit and to communicate with the responding communication unit using the first data rate;

and the responding communication unit comprising:

a second transceiver configured to receive interrogation signals from an interrogation source and to provide a response to the interrogation signals;

wherein the second transceiver is configured to identify to the interrogation source a data rate that is desired by the communication unit on providing the response to the interrogation signals and to communicate with interrogation source using the desired data rate.

According to an eighth aspect there is provided an apparatus comprising:

means for transmitting first radio signals adapted to interrogate communication units, and for responsively receiving second radio signals from a responding communication unit;

wherein the means for transmitting the first radio signals and responsively receiving the second radio signals being further configured to determine based on the first and second radio signals a first data rate desired by the responding communication unit and to communicate with the responding communication unit using the first data rate.

According to a ninth aspect there is provided a communication unit comprising:

means for receiving interrogation signals from an interrogation source and for providing a response to the interrogation signals;

wherein the means for receiving interrogation signals from an interrogation source and for providing a response to the interrogation signals being configured to identify to the interrogation source a data rate that is desired by the communication unit on providing the response to the interrogation signals and to communicate with interrogation source using the desired data rate.

The various embodiments illustrated in this summary are only non-limiting examples. It should be appreciated that corresponding embodiments may apply to other aspects as well.

### BRIEF DESCRIPTION OF THE DRAWINGS

The invention will be described, by way of example only, with reference to the accompanying drawings, in which:

FIG. 1 shows an exemplary simplified block diagram of a high data-rate Radio Frequency IDentity (RFID) system according to an embodiment of the invention;

FIG. 2 shows exemplary different data-rates of a scalable RFID system according to an embodiment of the invention;

FIG. 3A shows an exemplary response pattern for indicating a desired first data-rate by an RFID communication unit according to an embodiment of the invention;

FIG. 3B shows an exemplary response pattern for indicating a desired second data-rate by an RFID communication unit according to an embodiment of the invention;

FIG. 4 shows an exemplary flow-chart of an RFID reader according to an embodiment of the invention; and

FIG. 5 shows an exemplary flow-chart of an RFID communication unit according to an embodiment of the invention.

### DETAILED DESCRIPTION

In the following description, like numbers denote like elements.

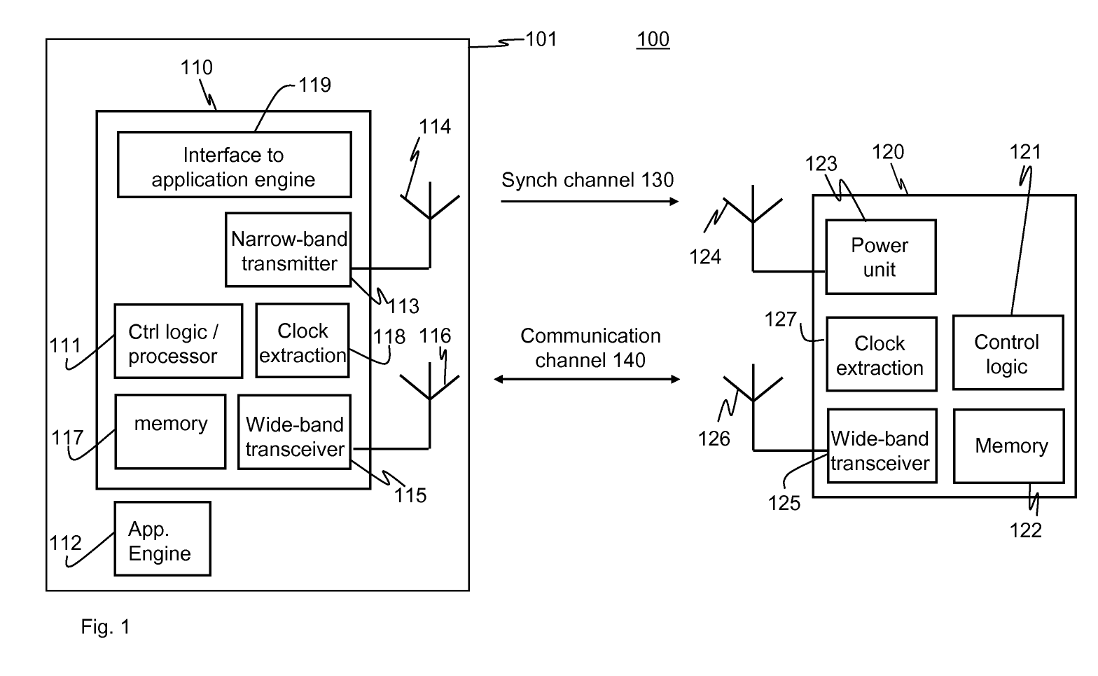

A simplified exemplary block diagram of the high data-rate RFID system 100 is presented in FIG. 1. The system comprises a host device 101 which has an RFID subsystem 110, an RFID communication unit 120, a synchronisation channel 130 and a communication channel 140, which channels may be separated or overlapping in frequency. It is observed that while it may be simpler to implement embodiments with separated frequency, ultra wide band communication may be arranged in a manner which tolerates overlapping narrow band transmissions by narrow band RFID communications and which does not excessively interfere with the narrow band RFID communications. The host device 101 may be a mobile telephone, game device, Personal Digital Assistant, or generally a portable or handheld device. The subsystem 110 comprises a control processor 111, a synchronisation transmitter 113, a synchronisation antenna 114, a communication transceiver 115, a communication antenna 116, a memory 117, a clock extraction unit 118, and an application engine interface 119. In the subsystem 110, the processor 111 controls the general operation of the host device using the computer program code. The memory 117 is drawn as a common logical storage for both computer program code controlling the operation of the host device 110, for maintaining volatile work memory data and for holding a buffer memory for detecting response signals received on the communication channel 140 for the control processor 111 to determine the timing of a responsive RFID communication unit 120. The buffer may also function as a cache buffering data received from the RFID communication unit 120 until the host device can supply the data to application layer processing. The application engine interface 119 is an interfacing unit that is used to connect the subsystem 110 to an application engine 112 in the host device. It is appreciated that in some embodiments the subsystem 110 may be incorporated into one or more integrated circuits of the host device 101 or provided as a standalone module.

The clock extraction unit 118 in the host device or reader may refer depending to embodiment to a clock extraction or local oscillator element. Namely, it is possible to implement the subsystem 110 such that the local oscillator signal that drives the narrow-band transmitter 113 is physically connected to the communication transceiver 115. In this case no clock extraction may be needed. In another embodiment, the powering signal is generated making use of another system supported by the subsystem 110, such as EPCGlobal or GSM. Even in this case, it may be advantageous to perform the clock extraction at the subsystem 110, because it may be problematic to conduct a signal in a frequency of the magnitude of 1 GHz to the communication transceiver 115.

The synchronisation channel may be a narrow band radio frequency channel such as a 13.56 MHz, 850 or 900 MHz radio channel. The communication channel may be a high-data rate communication radio channel such as an I-UWB channel. It should be appreciated that the terms synchronisation channel and communication channel are merely designating one use of these frequency bands without intention to reserve these radio frequencies solely for the synchronisation and communication functions. It will be appreciated that the synchronisation channel may be usable for providing the communication unit 120 with powering and/or a clock reference signal for use by the communication unit 120. It will also be appreciated that the communication channel may be used for exchanging synchronisation response signals from the communication unit 120 to the subsystem and after synchronisation phase for transmitting further information between the communication unit 120 and the subsystem 110.

The RFID communication unit 120 may comprise a processor or control circuitry 121 for generally controlling the operation of the RFID communication unit 120 according to computer program code that is adapted to control the operation of the RFID communication unit 120 in accordance with different embodiments of the invention. A memory 122 stores the computer program code and may store a significant amount of digital content. The RFID communication unit 120 may further comprise a power unit such as a rectifier that is typically designed to amplify voltage received from the synchronisation channel 130 radio signal. An antenna 124 may be provided for receiving the synchronisation channel 130 signal and further a communication channel transceiver 125 and communication channel antenna 126 may be provided for transmitting and receiving radio signals to and from the subsystem 110 over the communication channel 140. A clock extraction unit 127 may be provided for obtaining a clock reference from the reader 110. The clock extraction unit may be configured to functionally detect radio signal cycles from the synchronisation channel.

The processor 121 of the communication unit 120 and/or the control processor 111 of the subsystem 110 may be, for instance, a digital signal processor, microprocessor, application specific integrated circuit or control logic circuitry and significant amount of memory for storing digital content for transferring over the high data-rate link.

The communication unit may be an I-UWB tag. Depending on embodiment, the RFID communication unit 120 may be either active, that is self powered, in which case reception of radio power is not needed for tag energising, or passive, in which case the received radio power is needed for energising the tag. In either case, the I-UWB tags according to different embodiments of the invention may be configured to obtain a timing reference from a received narrow band RFID signal or particularly from a substantially continuous part of such a signal. Hence, the I-UWB tag may not need a local oscillator to generate short pulses with timing accuracy of the order of one or more nanoseconds. A 900 MHz UHF Industrial, Scientific and Medical (ISM) band signal has a cycle of about 1.1 nanoseconds and lower frequencies such as 13.56 MHz may be up-converted so as to obtain a suitable timing accuracy for the I-UWB tag. It shall be appreciated that in this description, a tag communicating with the reader may alternatively refer to another reader, but the terms tag and communication unit are used in sake of simplicity of explaining particular embodiments of the invention.

Basically, in some embodiments, the system enables wireless power transmission from a reader to an RFID communication unit by using a narrow-band signal and transferring communication data on another wider frequency band. This wider frequency band enables transfer of large amounts of data with a high data-rate using, for example, I-UWB transceivers. Particularly suitable frequency bands for wireless power transmission from the perspective of mobile phone integration are the frequency bands used by NFC (13.56 MHz) and the 900 MHz ultra high frequency band used for example by EPCglobal RFID systems. It is appreciated that different applications or purposes call for different operational ranges and thus different frequencies may be better suited for some embodiments of the invention. Depending on the applications desired for the mobile phone, a high data-rate (e.g. I-UWB based) RFID extension may be added on top of existing NFC reader functions and/or UHF RFID reader functions.

A high data-rate RFID tag may be capable of generating its supply voltage from several sources (by using widely known energy scavenging methods such as light, RF energy, vibration etc.). The default power source may be an RF signal and the tag may thus extract its supply voltage from received RF signals by using rectifier circuitry.

It should be appreciated that the aforementioned examples on 13.56 MHz and 900 MHz are not intended as an exhaustive list, but other frequencies may equally or even additionally be used, when RFID tags of different frequencies are being simultaneously accessed. Further still, a multimode tag may be provided with capability to operate on NFC and EPC signal frequencies as well as on 2.45 and/or 5 GHz signal frequencies.

It was disclosed in the foregoing that the subsystem 110 may comprise a control processor 111 or an RFID sub-system which controls the functions and scheduling of different transceivers/transmitters needed for RFID communication. The control processor 111 may control these functions according to commands and requests received from an application engine that is a normal part of some currently available smart phones provided by Nokia Corporation. The application engine may be configured, for example, to give a command that a narrow-band RFID scan/query procedure (e.g. NFC or EPCglobal) shall be executed periodically as a background process.

Depending on its configuration, the subsystem 110 or reader in short may be capable of reading RFID tags communicating according to legacy systems such as NFC and tags communicating over high data-rate air-interface which receive the supply voltage and clock reference from a narrow-band signal on e.g. 13.56 MHz frequency. Alternatively or additionally EPCglobal tags and high data-rate RFID tags may be powered by using the 900 MHz ISM band.

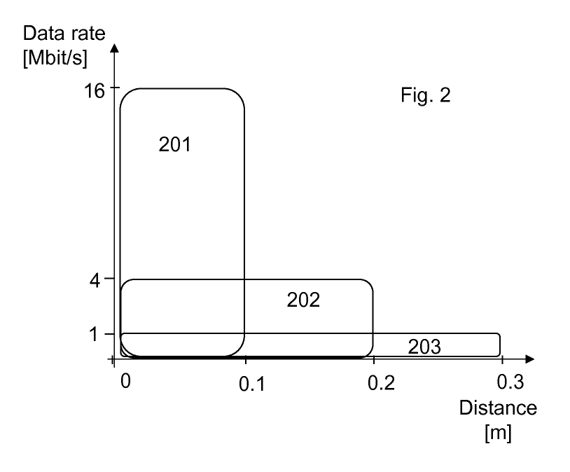

Impulse UWB systems are inherently scalable in data-rate and performance. FIG. 2 illustrates some exemplary data-rates of an impulse UWB based RFID system according to an embodiment of the invention. In this embodiment, there are three data-rates: high 201, medium 202 and low data rate 203. The ratio between the data-rates of different levels is 4 so that the high data-rate is, for example, 16 Mbit/s whereas the data-rate on medium data rate is one fourth of that (4 Mbit/s) and the data-rate on a low data rate is still divided by 4 (resulting as 1 Mbits/s). The data-rate affects on power consumption of the transceivers, as do the memory and other functions of a wirelessly powered in the tag. Hence, maximum communication ranges may vary on different levels. For the high data rate, the exemplary maximum range may be limited to 10 cm, whereas 20 cm and 30 cm may be respectively the operational ranges with the medium and low data rates. It is also feasible in some embodiments to scale amplitude and duration of pulses depending on the data-rate level. On the high data-rate, shorter pulses and lower amplitude may be applied whereas on a low data-rate, higher pulse duration with larger amplitude may be practical so as to seek for easier timing of transmitted and reflected pulses.

The communication data-rate may be up or down-scaled depending on the active operations as well as or instead of the available power in a tag. For example, the highest data-rate may be used when the distance between devices is short and a large data-transfer (such as transferring a large file) takes place. However, the low data-rate may be selected on the same distance to keep the radio link active while there is a pause in the fast data-transfer. For instance, the reader may be waiting for user input. A tag 120 may also support only particular data-rates. It is expected that at some point of time, there may be occasions in which some surrounding tags only support for medium and low data-rates and some other tags support all data-rates. A tag may also use further or alternative criteria for selecting a desired data rate. For instance, other properties of tags such as access rate of memory, a tag application or tag type may contribute to such criteria.

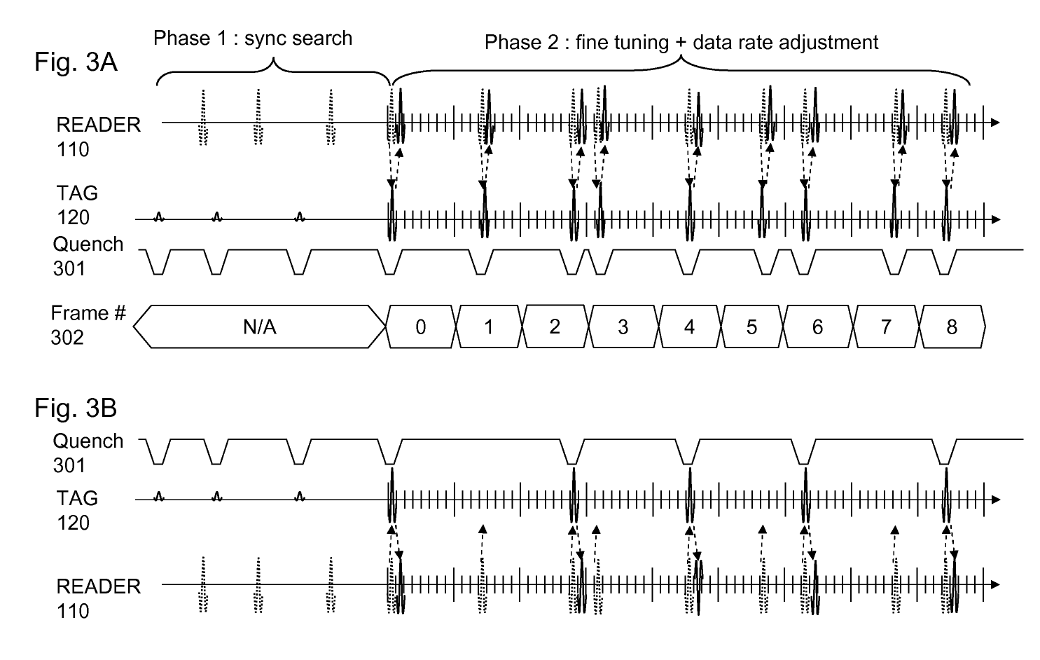

FIGS. 3A and 3B illustrate an example on how a tag may indicate desired data rates by applying predetermined response patterns as shown respectively with these two drawings on a common time scale. In FIGS. 3A and 3B exemplary signals drawn in hashed and solid lines are impulses transmitted by reader 110 and tag 120, respectively. First, before the period illustrated by the timeline of FIGS. 3A and 3B, there may be a frequency synchronisation phase 0 in which the tag and reader are frequency synchronised to each other so that they share a common clock reference. After phase 0, in phase 1, the reader and the tag may lack a common timing. In this phase, the reader and the tag may try to reach a phase synchronization using pulsed back-scattering principle as described in a co-pending European patent application number 07119336, incorporated herein by reference. In an exemplary embodiment in the EP application 07119336, a quench signal controls the timing of a super-regenerative transceiver. At a transmitter side, the quench signal may control timing of transmitted pulses. At a receiver side, the sensitivity periods of the receiver may be controlled by the quench signal. The transceiver structure may be such that a received pulse initiates a transmission of a pulse to the opposite direction. In FIGS. 3A and 3B, the tag 120 produces a string of quench signal periods 301 in order to alter reflection of signals from the tag 120 to the reader 110. If a pulse arrives from the reader 110 in a suitable alignment with a quench 301, the quench signal may cause a radiation pulse back to the reader 110. Once the reader 110 detects a response from the tag 120, the synchronization is found and both the reader and the tag may proceed to phase 2 for fine tuning of the timing between the tag and reader.

In FIGS. 3A and 3B, the transition from phase 1 to phase 2 denotes a common timing reference point for both the reader and the tag. As an example on a communication protocol a simplified protocol is used for exemplary purposes only. It is assumed that during phase 2, the reader may transmit exactly one pulse in each frame. Each frame may be split into eight time slots and the location of the transmitted pulse may follow a predetermined pseudorandom sequence. In FIG. 3A, for example, the reader transmits a pulse at the following points in time: frame 1 at slot 3, frame 2 at slot 6, frame 3 at slot 1, and so on. In this example, the slots are numbered from 0 to 7. It shall be appreciated that the timing of one reflection may be defined in different ways. In FIG. 3A the reader transmits and receives pulses during dedicated slots. However, in an alternative embodiment both functions are performed during a common slot period.

FIG. 3A represents a case where the tag desires to use a full transfer speed. When the transition from phase 1 to phase 2 occurs, the tag 120 starts to follow the same time-hopping sequence that is used by the reader. The tag activates its quench signal according to this sequence so that each pulse transmitted by the reader is captured in the tag and also reflected back to the reader. This indicates to the reader that it should start the actual data transfer using full speed (i.e. one bit in each frame).

The example shown in FIG. 3B is closely similar to the example discussed above, with the exception that now the tag desires to use lower data transfer speed. Instead of capturing (and reflecting) each of the pulses transmitted by the reader, the tag activates its quench only at every second frame. In other words, only half of the available frames are used and this indicates to the reader that it should use only 50% of the full transfer speed. As shown in FIG. 3B, the transceiver at the tag side is active only during frames with even number and the incoming pulses that occur within odd frames are intentionally skipped. When moving to data transfer phase, the reader should obviously not transmit anything during those frames that are ignored by the tag in order to minimize power consumption at reader side.

There are many possible variations to the data rate selection mechanisms described above. In more generic terms, the data rate selection of particular embodiments may be described so that the reader 110 transmits a sequence of pulses using a predetermined timing pattern. By selectively capturing and reflecting only part of the incoming pulses, the tag 120 may adjust the used data rate so that the data rate is lower than the full available data rate or higher than the lowest available data rate.

The robustness of the system may be improved so that on different data-rates, the active slots within frames do not occur at the same time. This method can be used by one of the devices in the system to further verify the selection of data-rate. In other words, if the reader has detected reflections during certain slots and concluded that the tag has selected a particular data-rate, the reader may determine that the conclusion was most probably correct, if no reflections occur during the slots reserved for other data-rates.

Different embodiments of the invention have associated advantages, including that:
The maximum or most suitable (optimal) data rate may be selected already during the fine-tuning phase (on PHY layer) without interaction or negotiation on upper layers of the system.
Tag-originated data-rate selection mechanism is possible so that the tag may select the data rate based on its own criteria such as power level (which also indicates distance to some extent)
The data rate selection may be also based on other criteria such as tag capabilities and/or tag type
Although the data-rate may be selected based on the resources of the tag, most of the additional functionality needed to detect the data-rate may be added to the reader side.
The reader may also estimate the distance between devices based on the data-rate proposed by the tag.

In one embodiment, after the reflection(s) used as a time-stamp for the starting of a fine-tuning period, the reader device 110 detects reflection(s) on different data-rates by starting from the highest supported data rate. The duration T_{f,h} of one frame at a highest data-rate may be one fourth of the duration T_{f,m} of one frame at the medium data-rate which may be one fourth of the duration T_{f,l} of one frame at a low data-rate. Then, the equation T_{f,l}=4·T_{f,m}=16·T_{f,h} is valid and the duration of a frame on the slowest frame-rate is 1/16 of the duration of a frame on the high frame-rate. The number of slots per frame on different frame-rates may also vary. In an exemplary case, there may be 8 slots per frame on the low and medium data-rates and 4 slots per frame on the high data-rate. During one frame only one slot, corresponding with one transferred symbol, may be active. In this case a simple on-off-keying (OOK) may be used since the distance between devices is very short. Further, there may be a predetermined sequence defining which of the slots are active by a time-hopping sequence. Time-hopping sequences are traditionally used in I-UWB systems to smooth transmission spectrum. Exemplary parameter values according to an embodiment are provided in the following table 1:

TABLE 1
Exemplary values for different parameters.

| Data-rate | High | Medium | low |
|---|---|---|---|
| Frame-rate [Mb/s] | 16 | 4 | 1 |
| Frame duration [ns] | 62.5 | 250 | 1000 |
| Slots per frame | 8 | 16 | 32 (or 64) |
| Slot duration [ns] | 4.1 | 15.6 | 31.3 (or 15.6) |
| Example pulse duration [ns] | 2 | 4 | 6 |

As mentioned already, in phase 2 the reader may start from the highest data-rate and detect for the reflections during the first four frames on the highest data-rate (excluding the first frame which may be reserved in this case for the future use). If the tag is capable of communicating with the highest data-rate the tag responses to the pulses coming from the reader. If the reader detects reflections during the pre-defined slots i.e. time-slots the reader may continue the fine-tuning sequence on the highest data-rate and finally set up the connection with the tag with the same data-rate. In an embodiment, the reflections are continued until communication phase i.e. phase 3 in which the tag and reader are communicating. It should be noticed that if the fine-tuning period continues with the highest data-rate, certain frames are not used for the highest data-rate since they are dedicated for lower data-rates (medium and low in this case). The reason is that to make the detection of selected data-rate as robust as possible, the proposed method can be implemented so that active time-slots on different data-rates do not overlap with each other. In other words, the timing of impulses on different rates does not overlap before the data-rate selection procedure has been completed. Thus it may be possible to avoid a situation in which pulses with different pulse parameters (e.g. duration or amplitude) could be expected to occur during the same time-slot.

In the foregoing, a case was disclosed in which the tag was capable of communicating with the highest data-rate. However, if the tag is not capable of communicating with the highest data-rate or if the tag otherwise selects a lower data-rate level due to some other reason, no reflections may occur during the four first high data-rate frames so that the reader continues to transmit pulses on the next data-rate. In this case the reader transmits pulses with the parameters suitable for the medium data-rate communication and medium range. This situation is analogue to the detection of data-rate during the highest data-rate period. If no reflections are detected by the reader, the reader moves on to the lowest data-rate. However, if a sufficient number of reflections are detected during the medium data-rate detection period, a fine-tuning period is finalized with the medium data-rate and frames/slots dedicated for the lowest data-rate may be skipped. Normally, the reader may be so configured with different data rate query patterns that there is sufficiently time to determine whether the tag 120 is capable of communicating with one data rate before it is time to proceed to testing another data rate, that is, before the first pulse of the second highest data rate sequence is going to be transmitted. In this exemplary implementation, three frames are used for the data-rate detection on a certain level before moving to the next level. This corresponds with the structure of ‘nested’ frames so that the first frame on every frame-rate is reserved for the detection of the higher frame-rate. However, more frames may be used for the detection on a certain level to achieve a more robust implementation.

In addition to or instead of pulse timing, other parameters of the high data rate RFID system may be varied for identifying a desired data-rate. These parameters include for example the amplitude of pulses, duration of pulses, timing between transmitted pulse and detection period, and pulse repetition rate (i.e. number of slots per frame). For example, higher amplitude of pulses may be practical to use on low data-rate to achieve the larger communication distance.

It may also be possible to make the data-rate selection during the data-transfer. This means that the data-rate selection procedure may be repeated after or during the communication period (in phase 3).

Advantageously, an embodiment of the invention that starts from the highest data rate may enable prioritising fastest tags in case of diverse supply of available tags. Let us assume that a number of tags respond to the reader substantially simultaneously. Hence, multiple simultaneous reflections arrive from multiple tags during the interrogation process. In this case, a tag with capabilities for the highest data-rate may be first detected and thus slower tags may be ignored. In that case, the existence of the nearest tag or at least the tag with the highest power level for operation may be first detected. In most cases, the distance and available power level correlates quite well or at least with the accuracy of the three data rate levels presented here, and in many use cases the nearest tag is the one that the user should wish to communicate with.

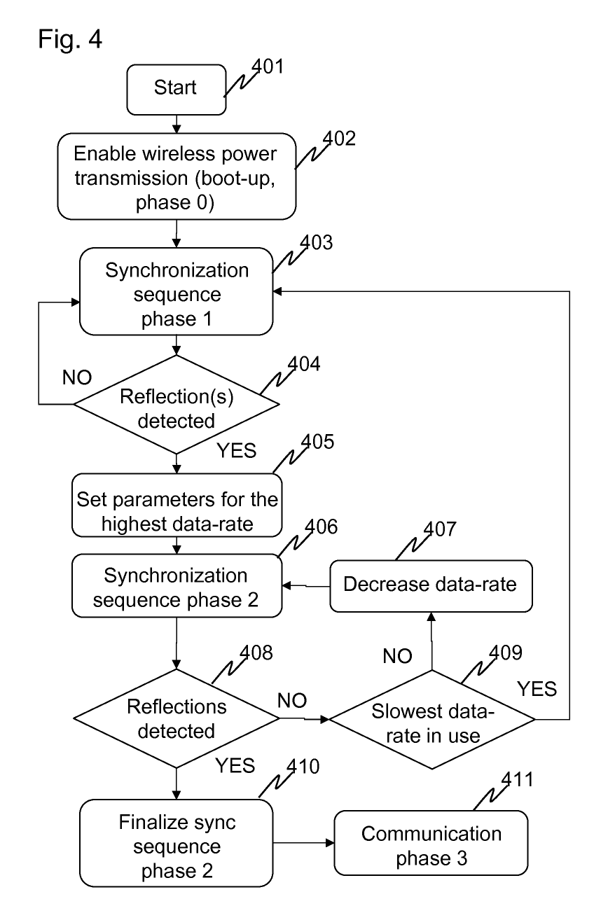

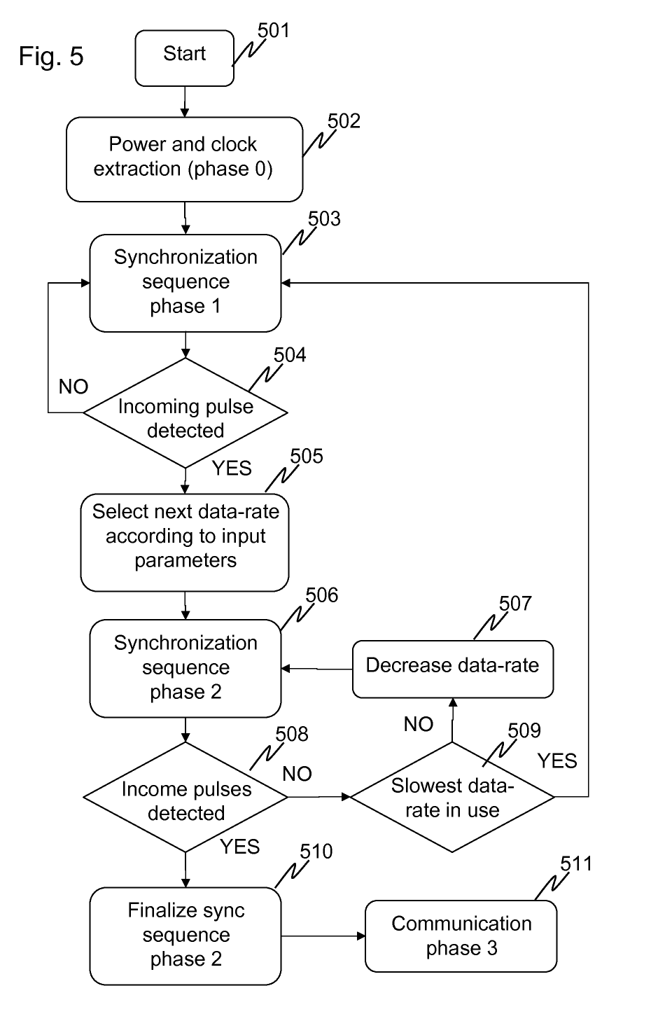

In FIGS. 4 and 5, exemplary functional flow-charts are presented of a reader 110 and of a tag 120 operating according an embodiment of the invention. As described above, the operation of both devices, reader and tag, starts from phase 0 described earlier in steps 401 and 501. In phase 0, the reader activates 402 the transmission of remote powering (narrow-band) signal and tag starts to extract power 502 and clock reference from that powering signal. As soon as the tag 120 and the reader 110 are ready, the tag and reader may transfer to a ‘synchronization search’ state (phase 1) 403, 503. The reader may then check 404 if it has detected reflection(s) and if no, return to step 403 and if yes, proceed to step 405 to set parameters for the highest data rate. Next, the reader 110 performs a loop of performing a synchronisation sequence phase 2 with the set parameters 406, checking 408 if reflections are detected, checking whether the lowest data rate was already tested 409 if no reflections were detected and decreasing the data rate 407 if still possible or resuming to the synchronisation sequence phase 1 if the lowest data rate was already in use. After the loop, when reflections were detected in step 408, the reader finalizes the synchronisation phase 2 in step 410 and proceeds to communication phase 411.

On the tag side, after step 503, the tag tries to detect an incoming pulse 504 and selects the next data rate according to input parameters 505. Next, the tag attempts 506 to perform a synchronisation sequence in accordance to the data rate determined by the input parameters. If incoming pulses are detected in step 508, the process advances to step 510 for finalising the synchronisation sequence of phase 2 and to communication phase 3 in step 511, but otherwise the tag tests 509 whether the lowest data rate was already in use. If not, the data rate is decreased 507 and the synchronisation sequence of phase 2 is attempted in step 506 with a new, lowered data rate.

The flow charts in FIG. 4 and in FIG. 5 are illustrative of various steps of different embodiments. It should be appreciated that the form, presence and order of the steps may vary in different other embodiments.

Advantageously, average data-rate may be increased in an I-UWB system, if the slowest synchronization sequence is used only in the very beginning of interaction.

It is appreciated that it may be advantageous to select the slowest level as the default data-rate in sake of better range of communication. When the reader and tag are first communicating with each other, they are not aware of the distance between them. Therefore it may be advantageous to start from the largest possible communication range and change to the more optimal data-rate as soon as possible. When the synchronization method is based on reflection of pulses, it is important to use pulse durations longer than the possible radio propagation period in order to achieve a robust system. Therefore, the lowest data-rate that covers the highest range should be used in the phase 1 for the first interaction. After the first interaction, the synchronization procedure may be later repeated using some other data-rate than the lowest one that was used in the phase 1. However, at that point of time the devices already have some knowledge about the counterpart device and probably about the distance between them, as well.

It is appreciated that one or more of the embodiments of the invention may involve an apparatus that may be, for instance, a unit for radio frequency identification, an interrogation source, a subsystem for radio frequency identification, a chipset or application specific integrated circuit configured to operate as a unit for radio frequency identification, a mobile, fixed, portable or handheld device, a mobile communication device, a mobile phone, a game station, a navigation unit, a health monitoring unit, or a personal digital assistant.

It is also appreciated that any software used to implement any feature or features of one or more embodiments may be distributed in a variety of different ways, for instance by pre-installing into a memory, transmitting over a wired or wireless connection, or providing on a memory medium. The distribution of such software may be provided as a cost bearing or free service and/or the distribution may be bound to a license agreement that has terms such as usage for life or for a given number of times and/or period, for instance.

The aforementioned reader may also be generally understood as an interrogation source, as for some embodiments there may not be any reading of content from a tag after the interrogation but instead an access may be made to transfer information to the tag from the interrogation source. Hence, term interrogation source may be used interchangeably with the term reader in one or more embodiments of the invention. An interrogation source may refer to a unit that is capable of interrogating responding tags.

Advantageously, the apparatus may allow a radio frequency identification unit to indicate during interrogation a data rate so that a connection may be readily established at a data rate that is suitable for the structure of the unit and its energy level.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means without deviating from the characteristics of the invention. For example, it is appreciated that the communication phase (phase 3) may be partly or entirely bidirectional or unidirectional in either direction depending on present needs and the capabilities of the equipment used.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. An apparatus comprising:
a transceiver configured to transmit first radio signals adapted to interrogate communication units, and to responsively receive second radio signals from a responding communication unit;
wherein the transceiver is further configured to determine based on the first and second radio signals a first data rate desired by the responding communication unit and to communicate with the responding communication unit using the first data rate; and
wherein the transceiver is further configured to determine the first data rate by testing different data rates and detecting associated responses.

2. (canceled)

3. An apparatus according to claim 1, wherein the testing involves transmitting data pulses during particular data frames and checking if responses are detected.

4. An apparatus according to claim 1, wherein the transceiver is configured to determine a predetermined response pattern as an indication of the first data rate.

5. An apparatus according to claim 4, wherein the transmitter is further configured to transmit predetermined pulses and the predetermined response pattern comprises selective responses to the predetermined pulses.

6. An apparatus according to claim 1, wherein the transceiver is configured to perform the determination of the data rate in connection with a second phase of interrogation in which a timing synchronization is being established between the apparatus and the responding communication unit.

7. An apparatus according to claim 1, wherein the first radio signals are adapted to interrogate radio frequency identification system communication units.

8. A method comprising:
transmitting first radio signals adapted to interrogate communication units, and responsively receiving second radio signals from a responding communication unit;
determining based on the first and second radio signals a first data rate desired by the responding communication unit;
communicating with the responding communication unit using the first data rate; and
determining the first data rate by testing different data rates and detecting associated responses.

9. (canceled)

10. A method according to claim 8, wherein the testing involves transmitting data pulses during particular data frames and checking if responses are detected.

11. A method according to claim 8, further comprising determining a predetermined response pattern as an indication of the first data rate.

12. A method according to claim 11, further comprising transmitting predetermined pulses; wherein the predetermined response pattern comprises selective responses to the predetermined pulses.

13. A method according to claim 8, further comprising performing the determination of the data rate in connection with a second phase of interrogation in which a timing synchronization is being established between the apparatus and the responding communication unit.

14. A method according to claim 8, wherein the first radio signals are adapted to interrogate radio frequency identification system communication units.

15. A computer program product comprising a non-transitory computer-readable medium having computer-executable instructions stored thereon, which when executed by a processor causes an apparatus to perform the method according to claim 8.

16. A communication unit comprising:
a transceiver configured to receive interrogation signals from an interrogation source and to provide a response to the interrogation signals;
wherein the transceiver is configured to identify to the interrogation source a data rate that is desired by the communication unit on providing the response to the interrogation signals and to communicate with the interrogation source using the desired data rate;
wherein the transceiver is configured to successfully respond to the interrogation signals only when the interrogation signals have a data rate desired by the communication unit.

17. A communication unit according to claim 16, wherein the transceiver is configured to communicate with the interrogation source using a predetermined response pattern so as to identify the desired data rate.

18. (canceled)

19. A communication unit according to claim 16, wherein the transceiver is further configured to receive the second radio signals from the responding communication unit in a radio frequency identification system.

20. A method comprising:
receiving interrogation signals from an interrogation source;
responding to the interrogation signals;
identifying to the interrogation source a data rate that is desired by the communication unit on responding to the interrogation signals and communicating with the interrogation source using the desired data rate, and
successfully responding to the interrogation signals only when the interrogation signals have a data rate desired by the communication unit.

21. A method according to claim 20, further comprising communicating with the interrogation source using a predetermined response pattern so as to identify the desired data rate.

22. (canceled)

23. A method according to claim 20, further comprising receiving the second radio signals from the responding communication unit in a radio frequency identification system.

24. A computer program product comprising a non-transitory computer-readable medium having computer-executable instructions stored thereon, which when executed by a processor causes a communication unit to perforin the method according to claim 20.

25. (canceled)

26. An apparatus comprising:
means for transmitting first radio signals adapted to interrogate communication units, and for responsively receiving second radio signals from a responding communication unit;
means for determining based on the first and second radio signals a first data rate desired by the responding communication unit;
means for communicating with the responding communication unit using the first data rate; and
means for determining the first data rate by testing different data rates and detecting associated responses.

27. (canceled)
